(19) United States
(12) Patent Application Publication
(10) Pub. No.: US 2026/0153013 A1
(43) Pub. Date: Jun. 4, 2026

(54) ENERGY DELIVERY SYSTEM FOR WIRELINE-BASED PULSED POWER APPLICATIONS

(71) Applicant: Halliburton Energy Services, Inc., Houston, TX (US)

(72) Inventors: Nagaraja K. Pai, Houston, TX (US); Wei Zhang, Houston, TX (US)

(21) Appl. No.: 18/963,919

(22) Filed: Nov. 29, 2024

(51) Int. Cl. E21B 41/00; E21B 17/00; E21B 23/14; H02J 7/00

(52) U.S. Cl. CPC E21B 41/00; E21B 17/003; E21B 23/14; H02J 7/50; H02J 7/855; H02J 7/865; H02J 7/927; H02J 2207/20; H02J 2207/50

(57) ABSTRACT

Some implementations include a wireline system configured for use in a wellbore drilled through one or more subsurface formations. The wireline system may comprise a power supply positioned at a surface of the wellbore and configured to supply electrical power, a wireline cable configured for deployment from the surface into the wellbore, and a wireline assembly configured for conveyance into the wellbore via the wireline cable. The wireline assembly may include an energy storage capacitor and one or more downhole tools configured to receive stored electrical power from the energy storage capacitor.

### TECHNICAL FIELD

The disclosure generally relates to wellbores formed in subsurface formations, and in particular, to wireline tools configured for use in a wellbore.

### BACKGROUND

In wireline applications, downhole tools may be powered by a direct current (DC) or alternating current (AC) power source located at the surface (e.g., of a wellbore). Power may be delivered to a tool and/or tool string suspended in the wellbore by a multi-conductor or a mono-conductor wireline cable. Many tools used in wireline applications may be configured to draw and use power uniformly. However, instantaneous power delivery to the tool may be limited by the impedance of the wireline cable. Some tools, like Magnetic Resonance Imaging Logging (MRIL) tools, may draw and deliver power in short pulses. In such cases, stored energy in a local capacitor bank may function as a power buffer.

### BRIEF DESCRIPTION OF THE DRAWINGS

Implementations of the disclosure may be better understood by referencing the accompanying drawings.

FIG. 1 is an illustration depicting an example wireline system, according to some implementations.

FIG. 2 is a block diagram depicting an example electrical system architecture, according to some implementations.

FIG. 3 is a circuit diagram depicting a high-level view of FIG. 2's electrical system, according to some implementations.

FIG. 4 is an illustration depicting an example wireline BHA coupled with a DC power source, according to some implementations.

FIG. 5 is an illustration depicting an example wireline BHA coupled with an AC power source, according to some implementations.

FIG. 6 is a plot depicting an example energy storage charging profile, according to some implementations.

FIG. 7 is an illustration depicting the example wireline system configured for use in an electrohydraulic fracturing operation, according to some implementations.

FIG. 8 is a block diagram depicting an example system architecture configured for pulsed power operations, according to some implementations.

FIGS. 9-10 are flowcharts depicting example operations for pulsed power operations, according to some implementations.

FIG. 11 is a flowchart depicting an example method of operations, according to some implementations.

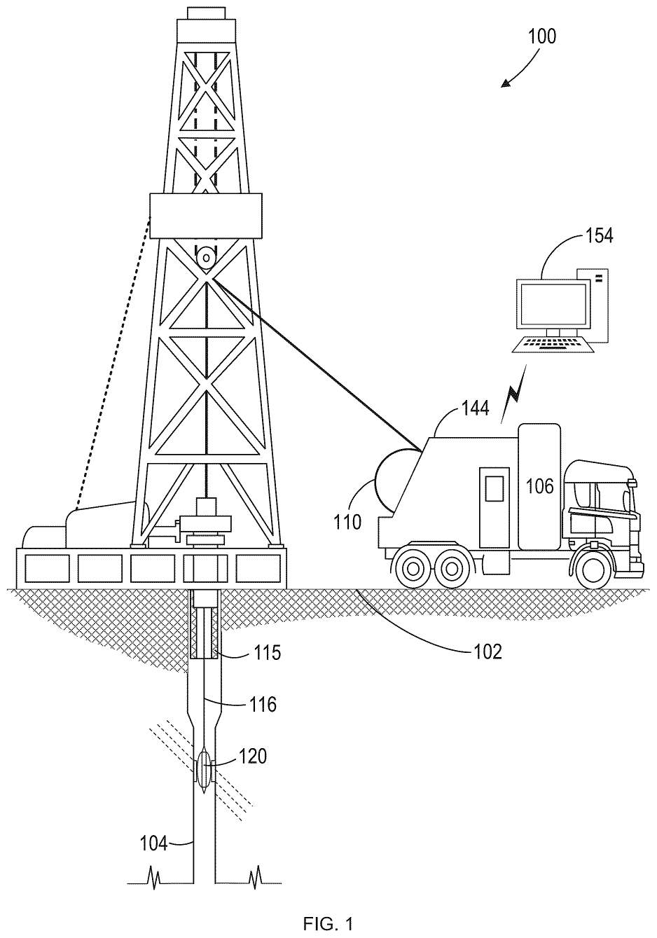

FIGS. 1-11 and the operations described herein are examples meant to aid in understanding example implementations and should not be used to limit the potential implementations or limit the scope of the claims. Some implementations may perform additional operations, fewer operations, operations in parallel or in a different order, and some operations differently.

The description that follows includes example systems, methods, techniques, and program flows that embody implementations of the disclosure. However, it is understood that this disclosure may be practiced without these specific details. In other instances, well-known instruction instances, protocols, structures, and techniques have not been shown in detail in order not to obfuscate the description.

### DESCRIPTION

Example implementations may include wireline systems configured for use with energy-focused pulsed power applications such as electrohydraulic fracking, well intervention, well stimulation, MRI Logging, pulsed power drilling using an electro-crushing drill, milling operations, plugging operations, etc. Example implementations may introduce configurations of a wireline system and power control components configured for efficient energy delivery to an energy storage capacitor and one or more pulsed power tools suspended via wireline. The wireline cable, which may introduce series impedance to a circuit, may deliver impedance-matched energy to the energy storage capacitor. This stored energy may be discharged to one or more pulsed power tools in the wireline bottomhole assembly (BHA).

Some implementations of the wireline BHA may include a boost charger, a high voltage energy storage capacitor, a high voltage, high current switch, a multimode control system which may control the boost charger (operating in either a constant current mode or a constant power mode), and a surface power supply output control system to maximize the system efficiency. The system described herein may optimize energy delivery for required pulse loading and its repetition frequency, ensuring efficient energy to the downhole tool. “High voltage” as described herein may refer to voltages between ten kilovolts (kV) and five hundred kilovolts. High current may refer to a current between two thousand and three thousand amperes (amps).

Traditional wireline systems may not be able to directly deliver sufficient energy to pulsed power tools for use in pulsed power operations at extended depths (e.g., greater than ten thousand feet of measured depth). However, charging the energy storage capacitor via the wireline cable over time and using the energy storage capacitor as the energy reservoir for downhole tools may enable an expanded portfolio of operations at an expanded range of depths. For example, the described energy storage capacitor may enable electrohydraulic fracturing operations, pulsed power milling operations, and other intervention/enhancement techniques at extended depths in a wellbore (i.e., greater than ten thousand feet of measured depth or true vertical depth). The use of a wireline cable may enable efficient energy delivery over a long distance. The use of the high-voltage energy storage capacitor to power downhole tools may also reduce costs associated with fracturing and well intervention, the portfolio of new operations to be performed by wireline may be expanded both for current and future wireline systems. The inclusion of the energy storage capacitor may enable existing wireline infrastructure to provide concentrated energy for well stimulation operations like electrohydraulic fracking.

### Example Illustrations

An example wireline system is now described. FIG. 1 is an illustration depicting an example wireline system, according to some implementations. A system 100 may be used in an illustrative subsurface environment to convey one or more devices into a wellbore 104. While depicted on the surface 102 as an onshore operation, example implementations may also be performed offshore. A surface system of FIG. 1 may include a power supply 106, which may be a medium voltage (between one to ten kV) or high voltage (between ten kV and five hundred kV) alternating current (AC) or direct current (DC) power supply. Some implementations of the power supply 106 may be greater than five hundred kV or less than one kV. The surface system may also include a wireline cable spool 110, a computer 154, and a wireline unit 144. The wireline unit 144 may include means to operate the wireline cable spool 110, such as a tool string push and pull mechanism with depth measurements. The wireline cable spool 110 may be operated by the wireline unit 144 to convey a wireline bottomhole assembly (BHA) 120 to a target depth in the wellbore 104. The wireline unit 144 may also include a data acquisition and operator console. Control mechanisms, telemetry, power control of the power supply 106, and data acquisition may be performed via the data acquisition and operator console. The data acquisition and operator console may be coupled with the computer 154. In some implementations, the computer 154 may be configured to perform the above functions of the data acquisition and operator console at the well site, remotely, etc.

Subsurface components of the system 100 may include a wireline cable 116 and the wireline BHA 120 within a wellbore 104 having a cased section via the casing 115. The wireline BHA 120 may include an energy delivery and management system including an input filter, a boost charger, a multimode control system, a high voltage energy storage capacitor, a high voltage, high current switch configured to tolerate the high voltage and current of the energy storage capacitor, and a tool string which may be configured for pulsed power functions including high energy magnetic resonance imaging (MRI), electrohydraulic fracking, etc. These components may be described with additional detail in later figures. High energy MRI may refer to MRI logging tools or operations which may require voltages greater than one kV and a supplied current greater than five hundred amps.

Subterranean operations may be conducted using the wireline BHA 120 once a drill string has been removed, though, at times, some or all of the drill string may remain in a wellbore 104 during logging with the wireline BHA 120. The wireline BHA 120 may include one or more devices which may be suspended in the wellbore 104 through a casing 115 by a wireline cable 116. The wireline cable 116 may comprise one or more conductive elements for transporting power from the power supply 106 positioned at the surface 102 to the wireline BHA 120. For example, the wireline cable 116 may include a mono-conductor or multi-conductor wireline cable. When using a multi-conductor configuration, one or more cables may be configured to transmit power to the wireline BHA 120 while one or more other cables may be used as an electrical return path. Some implementations of the wireline cable 116 may include a fiber optic communications cable configured to transmit telemetry and other data between the wireline BHA 120 and the wireline unit 144. Some implementations of the wireline cable 116 may include a coaxial communication cable to transmit data between the wireline unit 144 and the wireline BHA 120.

The wireline unit 144 may include or may be communicatively coupled to the computer 154. The computer 154 may include operating software to control one or more aspects of the wireline BHA 120 and/or the power supply 106. The wireline unit 144 may further include the wireline cable spool 110. The computer 154 may contain memory, one or more power storage devices, and/or one or more processors for performing operations, sending commands to, and storing measurements from the wireline BHA 120. In some implementations, the computer 154 may be positioned at the surface, within the wireline unit 144, at a different surface location, in the wellbore 104 as part of the wireline BHA 120, etc. (e.g., a portion of the processing may occur downhole and a portion may occur at the surface 102). The computer 154 may include a control system, a control algorithm, or a set of machine-readable instructions which may cause the data acquisition and operator console to generate and transmit an input signal to one or more elements of the wireline BHA 120 or the wireline unit 144. The wireline unit 144, while depicted as a wireline truck in FIG. 1, may be comprised of any structure. Similar to stationary facilities, implementations of the wireline unit 144 that utilize a wireline truck may be configured to provide both DC electrical power or AC electrical power to the wireline BHA 120. The wireline unit 144, whether using a stationary or mobile platform, may also be configured to couple with a transformer, a local power grid, and other power source for increased power delivery downhole. Other power supply configurations may also be possible. The wireline unit 144 may include computing facilities, including the computer 154, for controlling, processing, or storing telemetry data gathered from the wireline BHA 120. The computer 154 may be communicatively coupled to the wireline BHA 120 by way of the wireline cable 116. In one illustrative example, the wireline unit 144 may be a wireline truck capable of outputting one thousand five hundred volt (1.5 kV) power to the wireline cable 116 and wireline BHA 120.

In some implementations, the wireline BHA 120 may include a central body housing the input filter, the boost charger, the multimode control system, the high voltage energy storage capacitor, the high voltage, high current switch, and the tool string. Optionally, the wireline BHA 120 may include a number of extendible arms coupled to the body. One or more pads may be coupled to each of the extendible arms. Each of the pads may have a surface facing radially outward from the mandrel. During operation, the extendible arms may be extended outwards to a wall of the wellbore 104 to extend the surface of the pads to contact the wellbore 104. The one or more pads may retain a position of the wireline BHA 120 within the wellbore 104. In some implementations, the arms may include centralizers configured to centralize the wireline BHA 120 within the wellbore 104. For example, the centralizers may be used to center the wireline BHA 120 within a horizontal wellbore.

While traditional wireline cables may be able to transmit up to one hundred twenty five kilojoules (kJ) of energy downhole, this amount of energy may not be enough to sustain the operation of many energy and pulsed power tools. However, the use of an energy storage capacitor with the wireline cable 116 may enable energy tools to be used at depths greater than or equal to thirty thousand feet or forty thousand feet of measured depth within the wellbore 104. Positioning the energy storage capacitor in close proximity to the downhole tools as a downhole power source for energy and/or pulsed power tools may minimize losses during each pulse discharge.

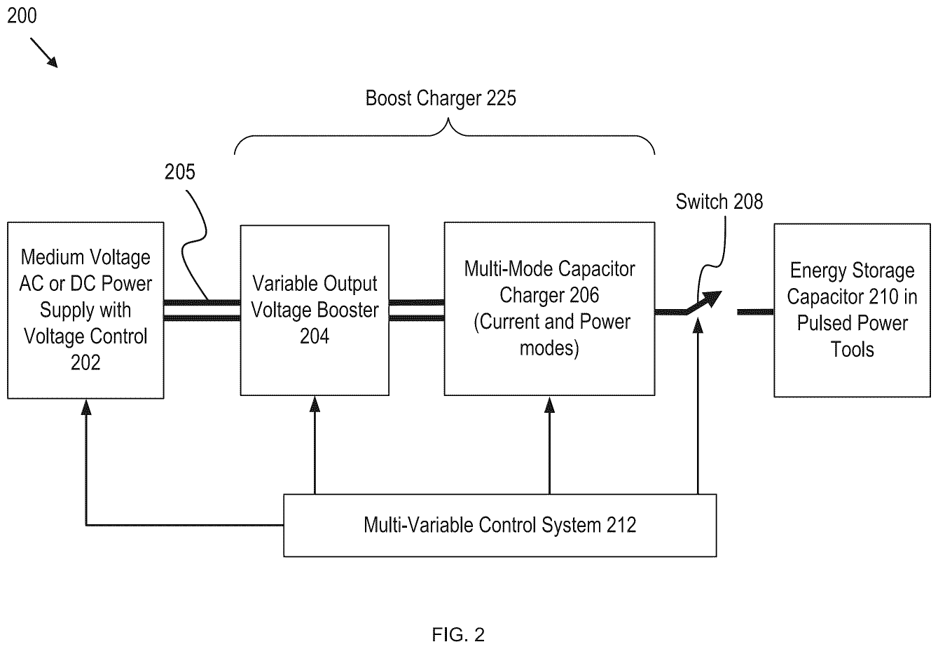

FIG. 2 is a block diagram 200 depicting an example electrical system architecture, according to some implementations. The block diagram 200 includes a medium voltage AC or DC power supply 202 with voltage control (“power supply 202”), a variable output voltage booster 204 (“voltage booster 204”), a wireline cable 205, a multi-mode capacitor charger 206 capable of operating in constant current or constant power modes, a switch 208, an energy storage capacitor 210 configured for use with one or more pulsed power tools (“energy storage capacitor 210”), and a multi-variable control system 212. The voltage booster 204 and multi-mode capacitor charger 206 may be included in a singular component referred to as a boost charger 225. In some implementations, the power supply 202 may be similar to the power supply 106 of FIG. 1. The variable output voltage booster 204, multi-mode capacitor charger 206, switch 208, energy storage capacitor 210, and the one or more pulsed power tools may be included as part of FIG. 1's wireline BHA 120. The wireline cable 205 may be similar to FIG. 1's wireline cable 116. The multi-variable control system 212 may be configured to control the boost charger 225 in either a constant current mode or a constant power mode. The multi-variable control system 212 may be configured to switch between the constant current and constant power modes. In some implementations, the multi-variable control system 212 may be positioned within the wireline unit 144 and may be coupled with the computer 154. The multi-variable control system 212 may control an output of the power supply 202 to improve system efficiency and optimize an energy delivery for required pulse loading and its repetition frequency to the energy storage capacitor 210.

The power supply 202 may be configured to deliver AC or DC power to an energy reservoir, such as the energy storage capacitor 210, within the wireline BHA 120. Output power from the power supply 202, positioned at the surface, may travel via the wireline cable 205 to the boost charger 225 in the wellbore. Some implementations of the wireline cable 205 may be comprised of a conventional wireline cable as part of a traditional wireline system to deliver power in a controlled mode to the boost charger 225. The power supply 202 may be in continuous communication with the boost charger 225, comprising both the voltage booster 204 and multi-mode capacitor charger 206. The voltage booster 204 may receive filtered electrical power output from an input filter at a first voltage and output boosted electrical power at a second voltage that is greater than the voltage of the filtered electrical power received as an input.

The wireline cable 205 may be configured to minimize conduction losses and total voltage drop as power travels from the power supply 106 at the surface 102 to the wireline BHA 120. Compared to traditional configurations which may use a downhole power generation device (e.g., a downhole motor, generator, turbine, alternator, etc.), the wireline cable 205 may be configured to deliver impedance-matched power to the wireline BHA 120 with minimal losses.

Current wireline systems may utilize a wireline cable 205 configured to deliver electrical power up to ten kilowatts (kW) to the boost charger 225. However, future wireline systems may be configured to transmit electrical power up to 100 kW from the power supply 202 to the boost charger 225. The electrical power conveyed via the wireline cable 205 may have a voltage up to six kilovolts (kV). However, some implementations of the power supply 202 may be capable of outputting voltages greater than six kilovolts. In this configuration, the wireline cable 205 may be configured with a smaller conductor diameter and an increased surface area of an exterior insulation. The power supply 202, boost charger 225, switch 208, energy storage capacitor 210, one or more pulsed power tools, and the multi-variable control system 212 may be configured to operate across the range of voltages. In some implementations, the amount of voltage sent through the wireline cable 205 may be controlled via wireline unit 144 and/or the computer 154 at the surface.

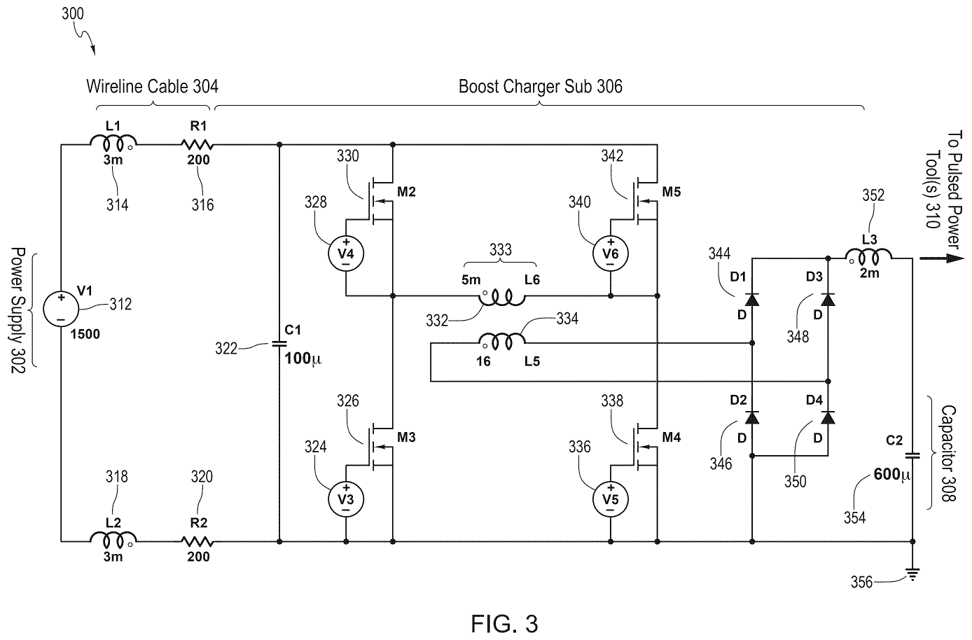

FIG. 3 is an example circuit diagram depicting a high-level view of FIG. 2's electrical system, according to some implementations. A circuit 300 includes a power supply 302, a wireline cable 304, a boost charger sub 306, and a capacitor 308 which may output power to one or more pulsed power tools 310. In some implementations, the power supply 202 may include a DC power source. The power supply 302 may be similar to the power supply 202 and power supply 106. The wireline cable 304 may be similar to the wireline cable 205 and wireline cable 116. The boost charger sub 306 may be similar to the boost charger 225. The capacitor 308 may be similar to the energy storage capacitor 210. The divisions between the components of FIG. 3 may be non-limiting, and individual electrical components including, but not limited to inductors, resistors, capacitors, controllers, processors, etc. may be shared between components or in a different order from that shown in FIG. 3. In some implementations, components of FIG. 3 may instead be replaced by other components or by additional hardware, firmware, software, etc. The circuit diagram is now described in an order similar to an order of power flow through the various components.

Electrical power within the circuit 300 may originate from a voltage source 312(V 1 ) of the power supply 302. This voltage source may be similar to the power supply 106. Power may be transmitted through the wireline cable 304, where the wireline cable 304 is represented by an inductor 314 (L1), resistor 316 (R1), inductor 318 (L2), and resistor 320 (R2). The wireline cable 304 may be coupled to a capacitor 322 (C1). The boost charger sub 306 may include the capacitor 322, a voltage source 324 (V3), a switch gate 326 (M3), a voltage source 328 (V4), a switch gate 330 (M2), a transformer 333 comprised of an inductor 332 (L5) and an inductor 334 (L6), a voltage source 336 (V5), a switch gate 338 (M4), a voltage source 340 (V6), a switch gate 342 (M5), a diode 344 (D1), a diode 346 (D2), a diode 348 (D3), and a diode 350 (D4). In some implementations, the capacitor 322 may be included as part of the input filter. The voltage sources 324, 328, 336, and 340 may also be referred to as controllers. Each of the voltage sources 324, 328, 336 and 340 may be configured to control the opening, closing, and timing of their respective switch gate.

The circuit 300 further includes a capacitor 354 (of the capacitor 308), an inductor 352 (which may be electrically coupled to the pulsed power tools 310, and a ground 356. In some implementations, each of the inductors 314, 318, 332, 334, and 352 may be comprised of an air coil, a coil surrounding a non-dielectric material or a soft magnetic material, a length of wire formed around a coil or toroidal core, a length of wire formed around a metallic or semi-metallic core, etc. Each switch gate of the switch gates 326, 330, 338, and 342 may be controlled by a controller (e.g., a boost charger controller). In some implementations, the switch gates 326, 330, 338, and 342 may be comprised of a gate driver. The gate driver may modulate a time duration and frequency to control a boosting of an input voltage and the charging of one or more capacitors. In some implementations, the switch gates 326, 330, 338, and 342 may be transistors including, but not limited to field-effect transistors (FETs), power metal-oxide-semiconductor FETs (MOSFETs), silicon carbide MOSFETs, solid state switches, insulated gate bipolar transistors (IGBT) or any other controllable transistor or combination thereof. Active control of the switching of the switch gates 326 330, 338, and 342 may allow for the modulation and/or adjustment of various characteristics of the electrical power as it is boosted within the boost charger sub 306 and output to a switch (and the pulsed power tools 310) from the capacitor 354.

The inductor 314 and resistor 316 of the wireline cable 304 may be coupled in series and connected to a positive terminal of the power supply 302, whereas the inductor 318 and resistor 320 may be coupled in series to a negative terminal. In one example, the power supply 302 may be configured to supply 1.5 kV to the circuit 300. However, higher voltage power sources (e.g., approximately 6 kV) and wireline cables suitable to transport the increased voltages may also be utilized. Power may be input into the boost charger sub 306 from the wireline cable 304. The boost charger sub 306 may be configured to increase an input voltage from the power supply 302 at the transformer 333. In some implementations, the transformer 333 may be a step-up transformer configured to increase a voltage of input power at a first winding (inductor 332) when output to the secondary winding (inductor 334). The switch gates 326, 330, 338, and 342 may be opened and closed to at desired frequency to induce a voltage at the inductor 332 via polarity reversals of a magnetic field at the inductor 332. For example, the switch gates 330 and 338 may be closed to induce a magnetic field at the inductor 332. The switches may subsequently be opened, and the switch gates 326 and 342 may be closed to allow current flow. These opposing switches may build and subsequently collapse a magnetic field at the inductor 332 with an opposing polarity than the magnetic field generated via the switch gates 330 and 338. Changing the polarity of the magnetic field at the inductor 332 may create higher peak to peak waveforms than the input voltage from the power supply 302. In one example scenario, an input voltage of 1.5 kV may be boosted to 100 kV via the transformer 333 of the boost charger sub 306. In other implementations, the boost charger sub 306 may increase the input voltage received via the wireline cable 304 to between 10-500 kV of output voltage to charge the capacitor 354, although other quantities may be possible. In some implementations, the voltage sources 324, 328, 336, and 340 may partially boost an input voltage and/or supplement the boosted voltage at the inductor 332 prior to delivery to the capacitor 354.

The boosted voltage may travel across the transformer 333 to the inductor 334 and to a charging circuit. The charging circuit may include the inductor 334, diodes 344-350, the inductor 352, the capacitor 354, and the ground 356. The charging circuit may be configured to charge the capacitor 354 (C2) and discharge energy from the capacitor 354 to the one or more pulsed power tools 310. After a boosted voltage is output from the inductor 334, current including the boosted voltage may flow from the inductor 334 to the diodes 344-350. This current may be lower than the input current to the transformer 333. The diodes 346 and 350 may be blocking diodes to prevent a ground short caused by current traveling to the ground 356. In some implementations, the current output from the transformer 333 to the charging circuit may be an alternating current. The diodes 344 and 348 may rectify the alternating current, and the inductor 352 may smoothen a rate at which current is input into the capacitor 354. The capacitor 354 may also be configured to further smoothen ripples of input current upon discharge.

The capacitor 354 may be a high voltage energy storage capacitor configured to store energy at a voltage between ten and five hundred kilovolts (kV). The capacitor 354 (also referred to as the capacitor 308) may have a higher capacitance than the capacitor 322. For example, the capacitor 354 may comprise a capacitance of six hundred microfarads (μ), while the capacitor 322 may include a capacitance of one hundred microfarads. Other values may be possible, and the size and/or capacitance of the capacitors 322 and 354 may be changed depending on the type of operation to be performed. For example, the capacitor 308 may be configured with a capacitance of one thousand microfarads for an EHF operation. In some implementations, the capacitor 308 may be rated to store and discharge between ten kilojoules (kJ) to well over one thousand kJ. For example, some implementations of the capacitor 308 may be configured to store and discharge five hundred kilojoules of energy. Some implementations of the capacitor 308 may be configured to store and discharge up to two megajoules of energy. Some implementations of the capacitor 308 may utilize multiple capacitors 354 in parallel, in series, etc. For example, the capacitor 308 may be considered a one thousand microfarad capacitor by utilizing ten 100-microfarad capacitors in parallel. The capacitor 308 may also utilize capacitors coupled in series, or a combination of capacitors coupled in series and capacitors coupled in parallel, etc.

The capacitor 354 may be coupled to a voltmeter which may be configured to measure the voltage across the capacitor 354. In some implementations, the charging and discharging of the capacitor 354 may be determined based on the voltmeter. Some implementations of the voltmeter may be coupled with the multi-variable control system 212 of FIG. 2. In one example implementation, a charging cycle of the capacitor 354 may be initiated based on the voltage of the capacitor 354. The switch to the pulsed power tools 310 may be opened, and current at a boosted voltage may supplied from the wireline cable 304 to the capacitor 354 via the transformer 333 of the boost charger sub 306. When the capacitor 354 is determined to be charged, the switch gates 326, 330, 338, and 342 may be configured to open, and the capacitor 354 may be discharged.

Some implementations of the capacitor 354 may discharge when the input voltage from the transformer 333 drops. To begin charging the capacitor 354 once again, the switches may be closed to generate the reversing polarity at the transformer 333. The frequency of charging and discharging the capacitor 354 may depend on the operation to be performed, the amount to which the capacitor's charge is depleted after each discharge, the type of discharge (i.e., single pulse versus burst discharge, etc.). The boosted output voltage of the boost charger sub 306 may be adjusted via a control system such as the multi-variable control system 212. This boosted voltage may determine the voltage level to which the capacitor 354 charges to. In one example, the output voltage from the step-up transformer (transformer 333) may be four hundred kilovolts. Therefore, the capacitor 354 may store energy and charge until it matches the four hundred kilovolt voltage output from the boost charger sub 306. Upon a voltage drop in the charging circuit, a command via the wireline unit 144 to close one or more switches to the pulsed power tool(s) 310 etc., the capacitor 354 may discharge.

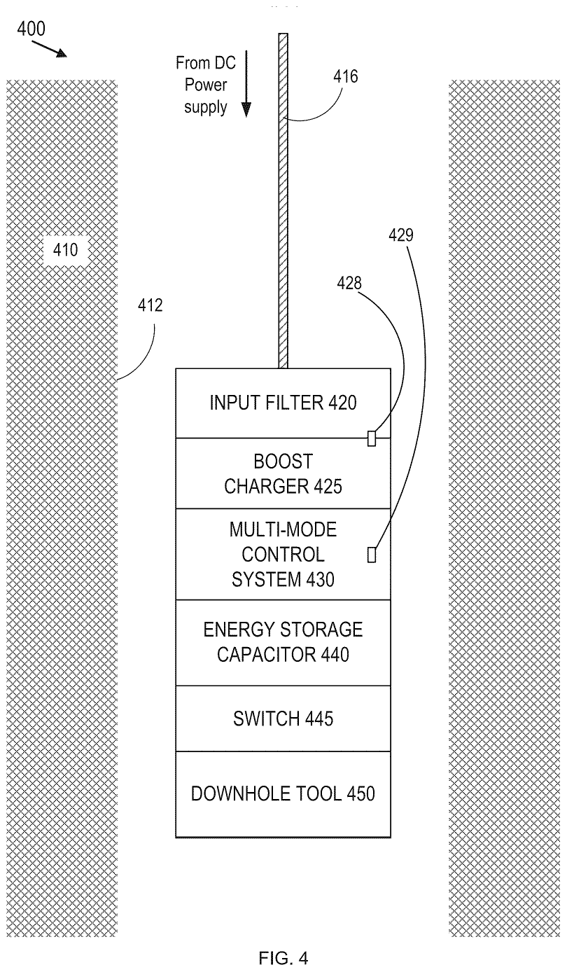

FIG. 4 is an illustration depicting an example wireline BHA 400 coupled with a DC power source, according to some implementations. The wireline BHA 400 may include an input filter 420, a boost charger 425, a multi-mode control system 430, an energy storage capacitor 440, a switch 445, and a downhole tool 450. In some implementations, the downhole tool 450 may include one or more pulsed power tools. The wireline BHA 400 may be conveyed into a wellbore 412 formed in a subsurface formation 410 via a wireline cable 416. The wireline cable 416 may be coupled with a DC power supply at a surface of the wellbore 412. The wireline BHA 400 may be conveyed to a target depth proximate to a subsurface formation 410 via the wireline cable 416. In some implementations, the downhole tool 450 may be comprised of multiple tools. Additionally, the wireline BHA 400 may include a boost charger controller 428 and a sensor 429. Some implementations of the switch 445 may include multiple switches. The boost charger 425, similar to the boost charger 225, may include a variable output voltage booster and a multi-mode capacitor charger

The DC power supply may be configured to deliver medium voltage or high voltage DC power via the wireline cable 416 to the input filter 420. In some implementations, the wireline cable 416 may be configured as a mono-conductor or multi-conductor cable. Some implementations of the multiconductor cable may comprise a seven conductor cable having three pairs of conductors (three cables for power transmission, three return lines, and one line for communication/data telemetry). Other cable configurations may also be possible.

In some implementations, the input filter 420 may be a capacitor used to reduce ripple voltage components, remove resonant frequencies, and smooth current and voltage waveforms from the DC power supply to provide a filtered electrical output to the boost charger 425. The input filter 420 may be a bi-directional input filter to ensure that high-frequency switching noise and other high-frequency characteristics of the boost charger 425 are not affecting upstream components within the wireline cable 416 or DC power supply at the surface. Alternatively, or in addition, the input filter 420 may be a low-pass filter, a high-pass filter, a band-pass filter, a band-stop filter, etc. The input filter 420 may condition input power before outputting power to the boost charger 425. Conditioning of the electrical power may include altering or controlling one or more electrical parameters associated with the received electrical power including, but not limited to voltage, current, phase, and frequency.

The boost charger 425 (comprising a voltage booster or similar power converter and a multi-mode capacitor charger) may be positioned below the input filter 420 and may be configured to receive the filtered electrical power output from the input filter 420. The multi-mode capacitor charger of the boost charger 425 may be configured to switch between a constant current mode and constant power mode to optimize charging of the energy storage capacitor 440. The multi-mode capacitor charger may switch between the constant current and power mode depending upon which mode charges the energy storage capacitor 440 the fastest.

DC power output from the power supply at the surface may be stored in the energy storage capacitor 440 prior to a discharge criteria being satisfied. For example, a discharge or load criteria may be satisfied upon an amount of energy being stored in the energy storage capacitor 440, after an elapsed time, etc. As an example, this criteria may be satisfied when the energy storage capacitor 440 is fully charged. In another example, this criteria may be satisfied when the amount of energy that has been stored is sufficient to perform a designated subsurface operation. For example, in an EHF operation, the discharge criteria may be a stored level of energy required to propagate one or more fractures in the subsurface formation 410. Accordingly, the amount of energy needed may vary depending on the type of rock. In another example, the discharge criteria may be a defined amount of time since a prior electrical discharge from the energy storage capacitor 440. Stored energy in the capacitor 440 may be discharged to the downhole tool 450 upon a closing of the switch 445.

The multi-mode capacitor charger may be configured to charge the energy storage capacitor 440 at a constant (i.e., not pulsed) rate. A charge rate of the energy storage capacitor 440 may be augmented depending on a desired rate of charging of the energy storage capacitor 440 and a desired number of pulses to emit via the downhole tool 450. In some implementations, the multi-mode capacitor charger of the boost charger 425 may be configured to switch between constant current and constant power modes to avoid overloading the energy storage capacitor 440. As an example, the multi-mode capacitor charger may begin charging at a constant current mode and may switch to a constant power mode when a power delivery limit of the DC power supply 302 has been reached, when the energy storage capacitor 440 reaches a full charge, when a downhole operation concludes, etc. Sustaining the constant power mode may cause the current to reduce over time, and the multi-mode capacitor may instead remain in the constant power mode or switch back to the constant current mode based on various system parameters. For example, the multi-mode capacitor charger may analyze load properties of the DC power source and energy storage capacitor 440. The multi-mode capacitor charger may avoid overloading the DC power supply and avoid choking the energy storage capacitor 440 by modulating between the two electrical modes.

The voltage booster and multi-mode capacitor charger of the boost charger 425 may work in tandem to charge the energy storage capacitor 440. In some implementations, the voltage booster and multi-mode capacitor charger may be contained within the boost charger 425. However, in some implementations, the voltage booster and multi-mode capacitor charger may be separate, distinct components that are used to boost the voltage of received power and to charge the energy storage capacitor 440, respectively. Some implementations of the boost charger 425 may be configured for single stage boosting and charging of the energy storage capacitor 440. The boost charger 525 may be configured to output a variable output voltage. This output voltage may be increased or decreased by commands sent from the surface (e.g., the wireline unit 144) via the boost charger controller 428. In some implementations, the boosting of the input voltage via the voltage booster may be performed at least partially in parallel with the charging of the energy storage capacitor 440 via the multi-mode capacitor charger (of the boost charger 425).

While a single boost charger 425 is depicted in FIG. 4, two or more boost chargers 425 may be used in the wireline BHA 400. Some implementations of the boost charger 425 may not be configured to boost an output voltage at all-rather, each boost charger 425 may only include a multi-mode capacitor charger. In implementations using multiple boost chargers, each of the boost chargers 425 may be configured to increase the input voltage stepwise until reaching the energy storage capacitor 440. In implementations using two or more boost chargers, each boost charger may be coupled with a respective energy storage capacitor 440.

The multi-mode control system 430 may be configured to control the components of the boost charger 425. Communication from the multi-mode control system 430 to the boost charger controller 428 may allow the multi-mode control system 430 to transmit data and/or modifications for charging the energy storage capacitor 440. Similarly, the boost charger controller 428 may be configured to transmit telemetry data to the wireline unit 144 at the surface of the wellbore 412. The multi-mode control system 430 may be configured to control the discharge of the pulsed power stored in the energy storage capacitor 440. The multi-mode control system 430 may measure data about the electrical characteristics of each of the electrical discharges and characteristics of the stored energy in the capacitor 440, such as power, current, voltage, etc. Based on information measured for each discharge, the multi-mode control system 430 may determine information about an example wireline operation. The multi-mode control system 430 may control the charge rate and charge voltage for each of the electrical discharges from the downhole tool 450.

The multi-mode control system 430 may be configured to determine whether at least one discharge criteria has been satisfied. The discharge criteria may be a criteria that a defined amount of energy has been stored in the energy storage capacitor 440. For example, the discharge criteria may be that the energy storage capacitor 440 is fully charged, charged more than a defined percentage of the full storage capacity (e.g., 99%, 95%, 90%, 50%, etc.), etc.

Another example criteria may be that a defined amount of time has elapsed since a prior pulsing of the electrical discharge. This defined amount of time may help ensure that the bottom of the drill string is in contact with a bottom of the wellbore prior to pulsing of the electrical discharge. In response to the discharge criteria being satisfied, the multi-mode control system 430 may cause the energy storage capacitor 440 to release the stored energy from the energy storage capacitor 440 through the downhole tool 450, resulting in a pulse of electrical discharge from the wireline BHA 400. In some implementations, this pulse discharge may be emitted into the subsurface formation 410. This pulsing of the electrical discharge may continue to occur periodically in response to the discharge criteria being satisfied.

The energy storage capacitor 440 may be configured to store energy at a high voltage (e.g., between ten kV and five hundred kV) depending on operational requirements. The energy storage capacitor 440 may be configured for use in high temperature applications (e.g., greater than 150° F.) and may store upwards of 1.1 Megajoules of energy. The energy storage capacitor 440 may be configured to output a current between two thousand and three thousand amps at one hundred fifty kilowatts of power. The energy storage capacitor 440 may be a device between fifty to one hundred feet ft in length and configured to fit within a variety of wellbore diameters. In some implementations, energy storage capacitors configured for use in slim-hole wells may be longer than those used in traditional-diameter wellbores.

The energy storage capacitor 440 may be used downhole rather than a battery storage system because of its superior rate of discharge. The energy storage capacitor 440 may be configured to deliver near-instantaneous, high voltage (ten to five hundred kV) pulses to the downhole tool 450. The voltage output from the energy storage capacitor 440 may be adjusted via the multi-mode control system 430 and its actuation of the switch 445. In some implementations, the energy storage capacitor 440 may reach a full charge within one to five minutes, depending on the wireline configuration of the wireline cable 416. The energy storage capacitor 440 may be configured to emit burst discharges during a discharge cycle. For example, two or more pulses may be delivered in a burst sequence, where each pulse includes up to five hundred Megawatts (MW) of power. In some implementations, a discharge cycle of the energy storage capacitor 440 may be configured to deliver a single pulse discharge. For example, a single discharge from the capacitor 440 at peak energy storage may exceed one Gigawatt (GW) of power, such as those used in EHF operations. Using singular pulse discharges or burst pulse discharges may be controlled via the multi-mode control system 430 depending on the pulsed power operation to be performed.

The downhole tool 450 may comprise one or more energy tools configured for use in well interventions, milling, pulsed power drilling, and other operations. In some implementations, the wireline BHA 400 may include an optional pulsed power transformer when configured for pulsed power drilling, electro-crushing operations, and/or milling operations. Example energy tools may include one or more MRIL tools, one or more high-energy NMR tools, one or more milling tools, one or more electro-crushing tools having one or more electrodes, one or more well stimulation tools, one or more well intervention tools, one or more EHF tools, one or more plugging tools, etc. Some implementations of the energy tools may include pulsed power tools. However, other tools may be configured to provide consistent power (i.e., non-pulsed). Other tools may also be possible. A high-energy NMR tool may refer to an NMR tool configured to emit pulses exceeding five kilovolts each. Pulses of ten kilovolts or higher may also be possible. In some implementations, a downhole tool 450 including an MRIL tool may be configured for burst discharges.

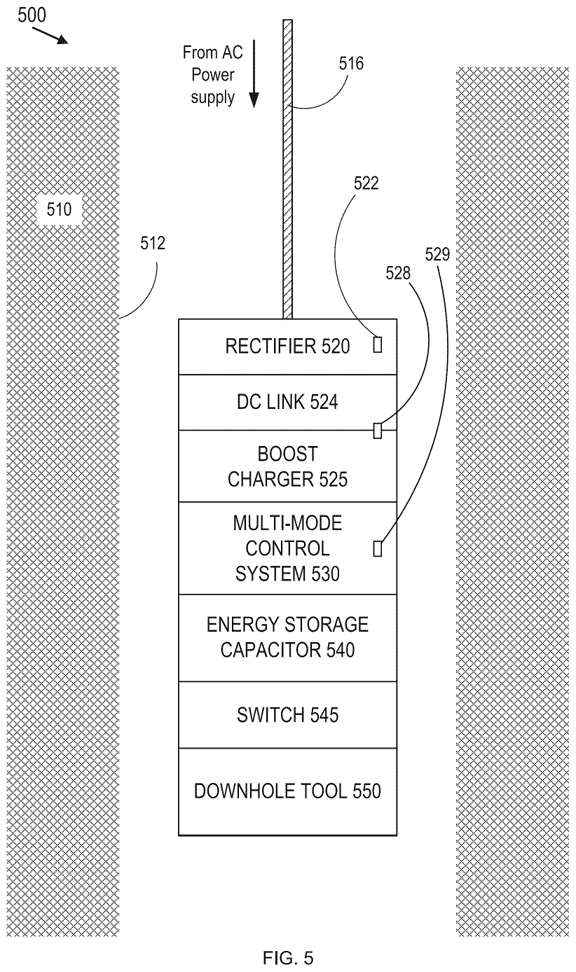

FIG. 5 is an illustration depicting an example wireline BHA 500 coupled with an AC power source, according to some implementations. Whereas the system of FIG. 4 may utilize DC power, the wireline BHA 500 may be configured to use AC power. This AC power can be rectified to convert the AC power into direct current (DC) power. The wireline BHA 500 may include a rectifier 520, a rectifier controller 522, a DC link 524, a boost charger 525, a multi-mode control system 530, an energy storage capacitor 540, a switch 545, and a downhole tool 550. Similar to the downhole tool 450, the downhole tool 550 may include one or more pulsed power tools. The wireline BHA 500 may be conveyed into a wellbore 512 formed in a subsurface formation 510 via a wireline cable 516. Additionally, the wireline BHA 500 may include a boost charger controller 528 and a sensor 529. Some implementations of the switch 445 may include multiple switches. The boost charger 525, similar to the boost charger 225, may include a variable output voltage booster and a multi-mode capacitor charger. The components shared between FIGS. 4-5, such as the boost charger, multi-mode control system, energy storage capacitor, switch, and downhole tool, may be configured to perform identical functions in either the AC or DC configurations.

The rectifier 520, the DC link 524, and the boost charger 525 may be configured to process the received AC electrical power from wireline cable 516 in order to provide a conditioned electrical power output comprising conditioned electrical power. The rectifier 520 may be configured to rectify the received power and smoothen and/or regulate frequency and/or waveforms of the received power. The boost charger 525 may include a voltage booster configured to boost the voltage output from the DC link 524. In operation, the rectifier controller 122 may control rectification functions performed by the rectifier 520, while the boost charger controller 528 may control voltage boosting functions. In some implementations, a single controller may control both the rectifier 520 and the boost charger 525.

Some implementations of the rectifier 520 may be a full wave rectifier. The rectifier 520 may include one or more controllable transistors which function as switches to aid in rectification of the electrical current output from the AC power supply. Rectification performed by the rectifier 520 may include rectifying the electrical current from the AC power supply to output a rectified current. The rectified current may be rectified AC or quasi-direct current (DC) (i.e., a square wave, sawtooth, etc. waveform). The rectified signal may be input into the DC link 524. Some implementations of the DC link 524 may output a variable voltage to the boost charger 525.

The voltage booster of the boost charger 525 may receive the output filtered electrical power from the DC link 524 and output a boosted electrical power having a voltage that is greater than the voltage of the filtered electrical power received as an input. In some implementations, the voltage booster may include a single-active bridge (SAB) having controllable transistors, one or more transformers, a diode bridge having one or more diodes, etc. Other configurations may be possible. In some implementations, the transformers may be solid-state transformers arranged in parallel. The transistors of the SAB may condition the filtered electrical power to generate parallel square wave electrical outputs, reducing current ripples at the output of each of the transformers. Generation of the parallel signals may reduce the electrical power level carried by each individual signal, which may enable the use of smaller and more compact transformers.

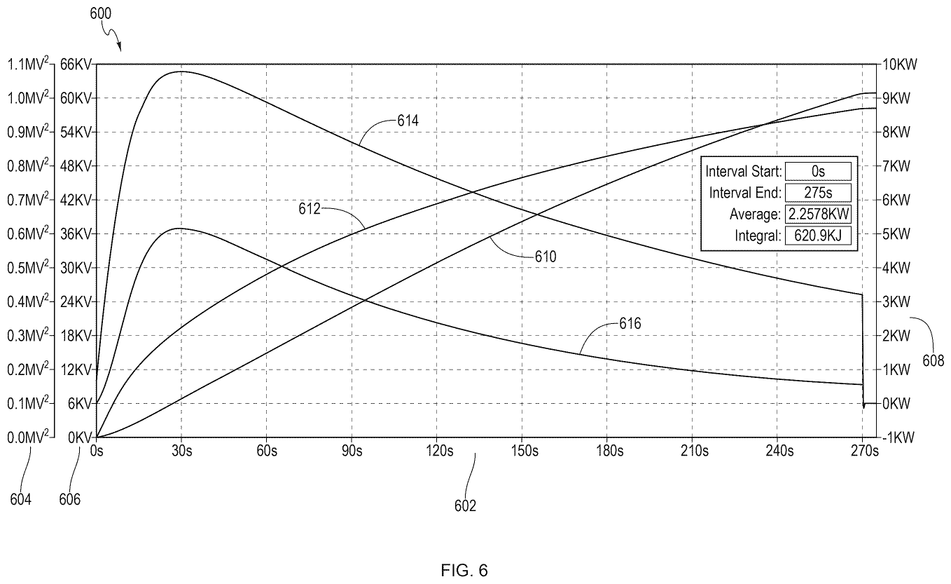

FIG. 6 is a plot 600 depicting an example energy storage charging profile, according to some implementations. The plot 600 includes an X-axis 602 of time in seconds, a first Y-axis 604 of stored energy (e.g., in the energy storage capacitor 210) in megajoules (MV²), a second Y-axis 606 depicting a voltage across the capacitor in kilovolts (kV), and a third Y-axis 608 depicting an input power through the wireline cable measured in kilowatts (kW). The plot 600 may represent a charging cycle of the energy storage capacitor prior to a discharge cycle.

Multiple curves of the plot 600 may represent charging and/or discharge characteristics of the components of the downhole energy storage system. Curve 610 models the energy stored in the capacitor over time, curve 612 depicts the capacitor voltage over time, curve 614 depicts the power provided from the surface via the wireline cable, and curve 616 models the energy losses in the cable. The difference between the curve 614 and curve 616 may represent the available power to charge the energy storage capacitor. As shown, the energy storage capacitor may reach approximately fifty seven kV during a charge cycle before discharging, as shown by the curve 612. Some implementations of the energy storage capacitor may be configured to store approximately 1.1 megajoules of energy prior to discharging, as denoted by the curve 610. The energy storage capacitor may be configured to store the 1.1 megajoules of electrical energy after two hundred and seventy seconds have elapsed. Other values may also be possible. The wireline cable, represented by the curve 614, may be configured to transmit up to ten kilowatts of power to the energy storage capacitor downhole. Lower power levels for charging, such as one to two kilowatts (kW), may also be used.

Whereas other pulsed power operations may require high frequency (e.g., multiple discharges per second) and lower energy pulses (such as those used in pulsed power drilling), some implementations of the energy storage capacitor may be configured for use in higher energy, lower frequency applications. For example, the energy storage capacitor may reach a full stored energy capacity within five minutes or less of charging. The stored energy may be discharged, either in a single pulse or in a burst of pulses, to a pulsed power tool. For example, a single, high-energy (e.g., five hundred kilojoules to approximately one megajoule) pulse may be emitted into a subsurface formation to fracture a reservoir during an electrohydraulic fracturing operation. Other operations, such as MRIL, may utilize continuous power discharged from the energy storage capacitor. Periodic pulses may be emitted at intervals of every ten seconds, every minute, etc. depending on the pulsed power operation to be performed. Discharging the stored electrical energy in bursts may be especially useful for wellbore cleaning operations to loosen sediment, scale, and other debris within a wellbore.

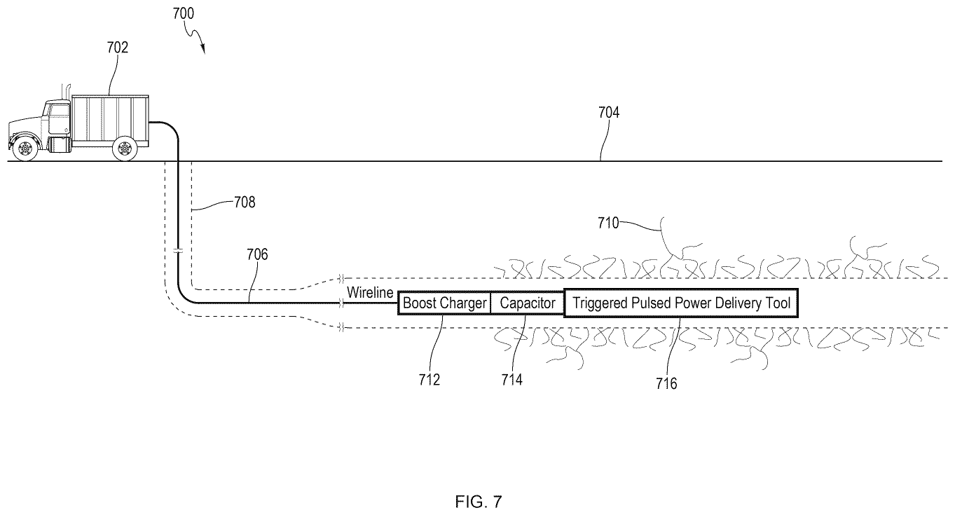

FIG. 7 is an illustration depicting the example wireline system 700 configured for use in an electrohydraulic fracturing operation, according to some implementations. The wireline system 700 may include a wireline unit 702 (depicted as a wireline truck), a surface 704, a wireline cable 706, a wellbore 708, a fracture network having multiple fractures 710, a boost charger 712, an energy storage capacitor 714, and a triggered pulsed power delivery tool 716. As shown, the wellbore 708 may be a horizontal wellbore. However, the wireline system 700 may also be used in vertical wellbores. The boost charger 712 may include a control telemetry module configured to couple with the wireline unit 702 via the wireline cable 706. The wireline cable 706 may be a mono-conductor or multi-conductor cable. The wireline cable 706 may be configured to deliver 1 million joules of energy in 270 seconds (approximately five minutes) to the energy storage capacitor 714.

In some implementations, the triggered pulsed power delivery tool 716 may be an EHF tool. During an electrohydraulic fracturing (EHF) operation, the wellbore 708 may be filled with a fluid. A pulse discharge from the capacitor 714 may be emitted by the triggered pulsed power delivery tool 716 to propagate the fractures 710 of the fracture network.

The triggered pulsed power delivery tool 716 may utilize a trigger. The trigger may be a switch, a gas discharge device, an instant in time, a predefined elapsed time, a timer, a measurement from a sensor which exceeds a preset threshold, etc. at which a function to be performed by the pulsed power delivery tool 716 is to be performed. Thus, the trigger may be configured to activate a pulsed discharge from the capacitor 714 to the pulsed power delivery tool 716. For an EHF tool, this may emit a pulse discharge into the fracture network to extend the fractures 710. For an MRIL tool, triggering the pulsed power delivery tool 716 may emit a burst of MRI pulses into the formation proximate to the wellbore 708. A switch between the energy storage capacitor 714 and triggered pulsed power delivery tool 716 may be closed upon activation of the trigger. Voltage from the capacitor 714 may then connect to the load, and the pulsed power delivery tool 716 may activate.

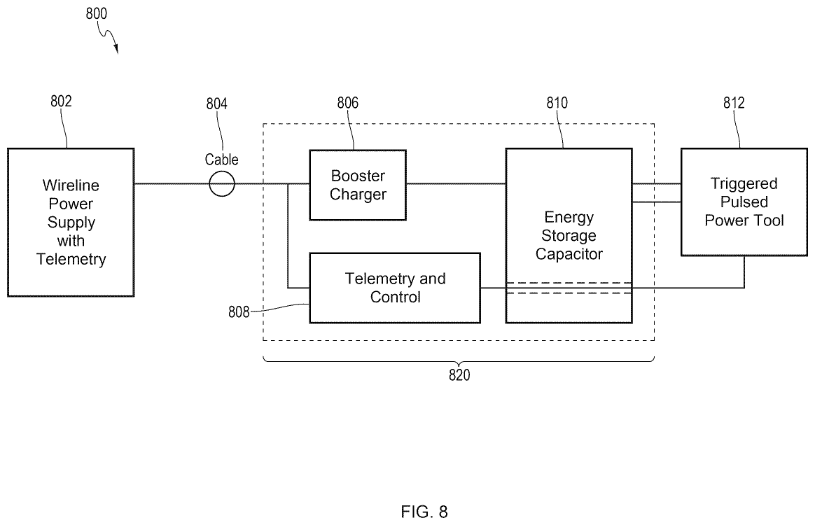

FIG. 8 is a block diagram depicting an example system architecture 800 configured for pulsed power operations, according to some implementations. The system architecture 800 may include a wireline power supply 802 which may include a telemetry system to receive data from a wellbore, a wireline cable 804, a booster charger 806, a telemetry and control module 808, an energy storage capacitor 810, and a triggered pulsed power tool 812. In some implementations, the booster charger 806, telemetry and control module 808, and energy storage capacitor 810 may be part of a wireline BHA 820. In some implementations, the telemetry and control module 808 may be similar to the multi-mode control system 430 of FIG. 4. The telemetry and control module 808 may be configured to control the charging and discharging of the energy storage capacitor 810. Each charging and discharging cycle may be based on a predefined time interval, a voltage across the energy storage capacitor, etc. The telemetry and control module 808 may be configured to control whether the discharge from the energy storage capacitor 810 occurs in a single pulse, a burst discharge, etc. during each discharge cycle. Some implementations of the telemetry and control module 808 may include a voltmeter to measure a voltage across the energy storage capacitor 810, to measure an input or output voltage from the booster charger 806, etc. The telemetry and control module 808 may be configured to alter the output voltage from the booster charger 806.

### Example Operations

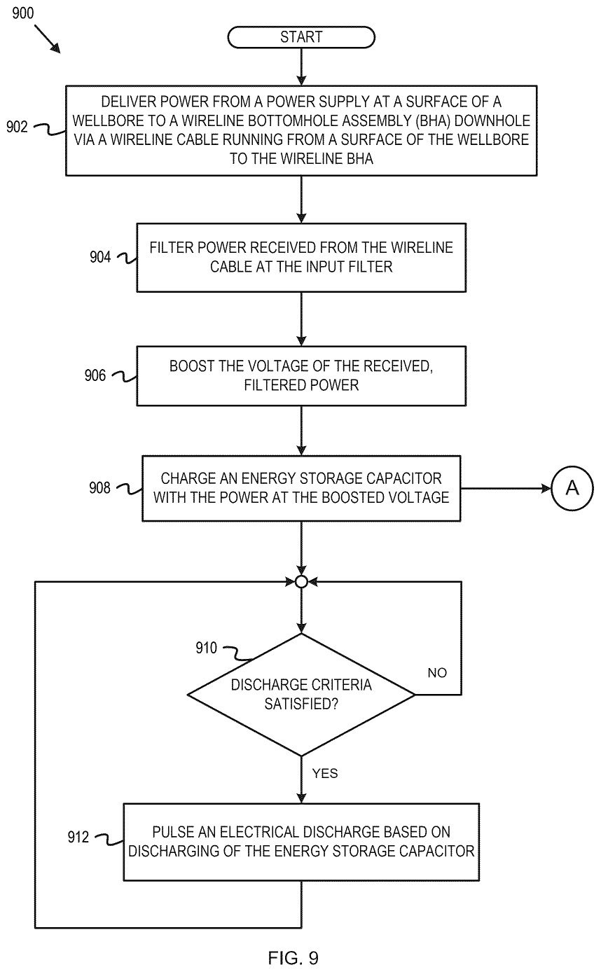

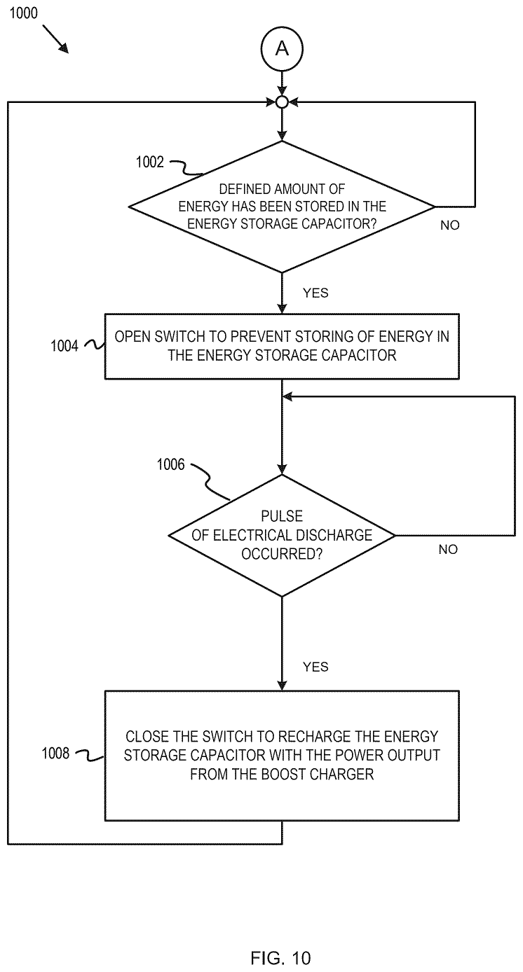

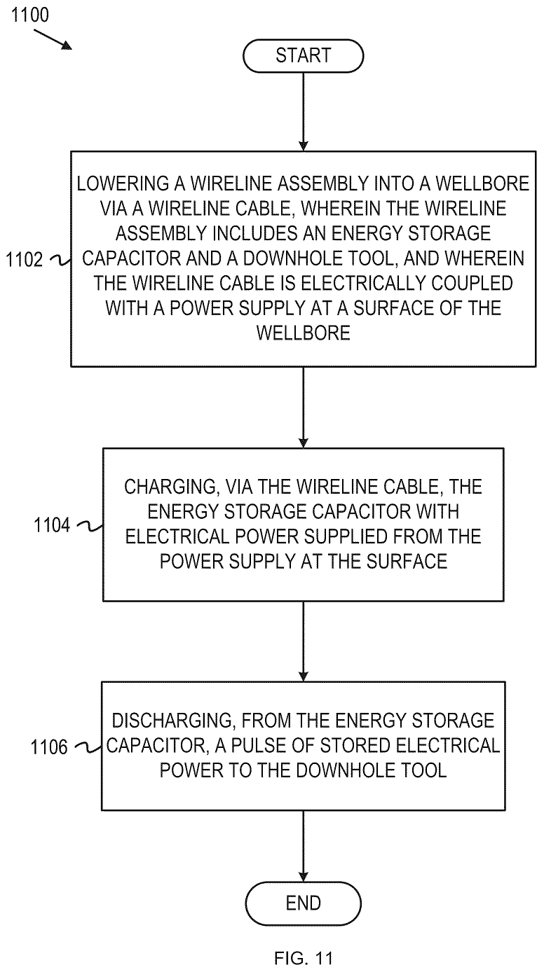

Example operations for pulsed power drilling are now described in reference to FIGS. 1-8. FIGS. 9-10 depict example operations for pulsed power drilling via cable-delivered power through coiled tubing. FIG. 11 depicts example operations for directional drilling for pulsed power operations.

FIGS. 9-10 are flowcharts depicting example operations for charging an energy storage capacitor in a wellbore, according to some implementations. Operations of flowcharts 900-1000 of FIGS. 9-10 continue between each other through transition point A. Operations of the flowcharts 900-1000 may be performed by software, firmware, hardware, or a combination thereof. Operations of the flowcharts 900-1100 are described in reference to the example system 100 of FIG. 1, but the operations may be applicable to any wireline system. The operations may also be applicable to any pulsed power system conveyed via wireline. Other systems and components may also be used to perform the operations now described. The operations of the flowchart 900 start at block 902.

At block 902, power from a power supply at the surface of the wellbore is delivered to a wireline bottomhole assembly (BHA) downhole via a wireline cable running from the surface to the wireline BHA. For example, with reference to FIGS. 1-3, the power may be delivered from the power supply 106 (or optionally, the power supply 202 or the power supply 302) at the surface 102 and down the wellbore 104 via the wireline cable 116. The wireline cable 116 may be conveyed from the wireline unit 144. Flow progresses to block 904.

At block 904, the received power from the wireline cable may be filtered at the input filter. For example, with reference to FIG. 4, the power received by the wireline cable 416 may be filtered at the input filter 420. The input filter 420 may condition the received power prior to being input into the boost charger 425. Flow progresses to block 906.

At block 906, the received and filtered power may have its voltage boosted at the boost charger. For example, with reference to FIG. 4, the boost charger 425 may boost the voltage of power output from the input filter from 2-6 kV to 10-500 kV, although other voltage values may be possible. Flow progresses to block 908.

At block 908, the boosted voltage output from the boost charger is used to charge an energy storage capacitor. For example, with reference to FIG. 4, the boost charger 425 may be used to charge the energy storage capacitor 440. From block 908, operations continue at block 910 and transition point A, which continues at transition point A of the flowchart 1000.

At block 910, a determination is made of whether a discharge criteria is satisfied. For example, with reference to FIG. 4, the multi-mode control system 430 may determine whether one or more discharge criteria is satisfied. For example, the discharge criteria may be a criteria that a defined amount of energy or a defined amount of voltage has been stored in the energy storage capacitor 440. An example may be that the energy storage capacitor 440 is fully charged, more than a defined percent (e.g., 99%, 95%, 90%, 50%, etc.), etc. Another example criteria may be that a defined amount of time has elapsed since a prior pulsing of the electrical discharge. Flow progresses to block 912.

At block 912, an electrical discharge is pulsed based on discharging of the energy storage capacitor. For example, with reference to FIGS. 4 and 8, in response to the discharge criteria being satisfied, the telemetry and control module 808 may cause the energy storage capacitor 810 to discharge stored energy to the triggered pulsed power tool 812. Alternatively, the multi-mode control system 430 may cause the energy storage capacitor 440 to release the stored energy from the energy storage capacitor 440 through the downhole tool 450. In some implementations, the pulsed discharge may be emitted into the subsurface formation 410 during, for example, an electrohydraulic fracturing operation. However, some pulse discharges may be emitted into the wellbore 412 for milling operations, wellbore cleaning operations, etc. The pulsing of the electrical discharge from the energy storage capacitor 440 may continue to occur periodically in response to the discharge criteria being satisfied. Accordingly, operations of the flowchart 900 may return to block 910 to determine whether a discharge criteria is subsequently satisfied.

Operations of the flowchart 1000 are now described. From transition point A, operations continue at block 1002.

At block 1002, a determination is made of whether a defined amount of energy has been stored in the energy storage capacitor. For example, with reference to FIG. 4, the multi-mode control system 430 may make this determination whether a defined amount of charge is stored in the energy storage capacitor 440. For example, the defined amount of charge may be that the energy storage capacitor 440 is fully charged, more than a defined percent (e.g., 99%, 95%, 90%, 50%, etc.), etc. In some implementations, the level of charge of the energy storage capacitor may be determined, at least in part, by a voltmeter configured to measure the voltage across the capacitor. If the defined amount of charge has not been stored, operations of the flowchart 1000 remain at block 1002 to again determine whether a defined amount of energy has been stored in the energy storage capacitor. If the defined amount of charge has been stored, operations of the flowchart 1000 continue at block 1004.

At block 1004, the switch is opened to prevent storing of energy in the energy storage capacitor. For example, with reference to FIG. 3, the switch gates 326, 330, 338, and 342 may be opened to prevent current flow to the capacitor 354. The switches may be opened once the capacitor 354 has reached a desired level of charge depending on the operation to be performed. Flow progresses to block 1006.

At block 1006, a determination is made of whether a pulse of electrical discharge has occurred. For example, with reference to FIG. 4, the multi-mode control system 430 may make this determination because the multi-mode control system 430 may control when a pulse of the electrical discharge happens. In particular, the multi-mode control system 430 may enable the releasing of the stored energy from the energy storage capacitor 440 through the downhole tool 450—resulting in the pulse of electrical discharge into the surrounding subsurface formation, into the wellbore, etc. The multi-mode control system 430 may close the switch 445 to release the stored energy in the energy storage capacitor 440 to the downhole tool 450. If the pulse of electrical discharge has not occurred, operations remain at block 1006 to continue monitoring for the pulse of electrical discharge. If the pulse of electrical discharge has occurred, operations continue at block 1008.

At block 1008, the switch may be closed to recharge the energy storage capacitor from the power output from the boost charger. For example, with reference to FIGS. 3-4, the multi-mode control system 430 alternate close a switch positioned between the boost charger 425 and the energy storage capacitor 440. This closed position would again allow the storing of charge in the energy storage capacitor 440. Operations return to block 1702, where a determination is made of whether the defined amount of charge has been stored.

Example operations for supplying power to a downhole energy storage capacitor via wireline are now described pulsed power drilling are now described. FIG. 11 is a flowchart depicting an example method of operations, according to some implementations. Operations of the flowchart 1100 may be performed by software, firmware, hardware, or a combination thereof. Operations of the flowchart 1100 are described in reference to FIGS. 1-10. However, other systems and components may be used to perform the operations now described. The operations of the flowchart 1100 start at block 1102.

At block 1102, a wireline assembly may be lowered into a wellbore via a wireline cable, wherein the wireline assembly includes an energy storage capacitor and a downhole tool, and wherein the wireline cable is electrically coupled with a power supply at a surface of the wellbore. With reference to FIGS. 1 and 4, the wireline bottomhole assembly 120 may be conveyed into the wellbore 104 via the wireline cable 116, where the wireline cable 116 is coupled with the power supply 106 and the wireline unit 144. The wireline BHA 400 of FIG. 4 may include the energy storage capacitor 440 and the downhole tool 450. Flow progresses to block 1104.

At block 1104, the energy storage capacitor may be charged with the electrical power supplied from the power supply at the surface via the wireline cable. For example, with reference to FIG. 4, the energy storage capacitor 440 may be charged from a surface power supply via the wireline cable 416. The energy storage capacitor 440, at full charge, may be configured to store over one megajoule of energy. Flow progresses to block 1106.

At block 1106, a pulse of the stored electrical power may be discharged from the energy storage capacitor to the downhole tool. For example, with reference to FIG. 4, stored charge may be discharged from the energy storage capacitor 440 as current to the downhole tool 450 in a singular discharge or burst discharge depending on the operation to be performed. Accordingly, pulses at varying energy levels may be emitted depending on the type of operation to be performed. With reference to FIG. 7, one example operation may include an electrohydraulic fracturing (EHF) operation in which a single discharge is emitted per discharge cycle of the capacitor 714. In one example, a single pulse discharge from the capacitor 714 for the EHF operation may be between twenty-five kilojoules and five hundred kilojoules. Lower or higher discharge values may also be possible. For an example pulsed power drilling operation, the capacitor 440 may discharge individual pulses each having one kilojoule of energy. In an example magnetic resonance imaging (MRI) operation, the capacitor 440 may discharge one hundred kilojoules of energy in a singular or burst pulse discharge. Flow of the flowchart 1100 ceases.

The flowcharts are provided to aid in understanding the illustrations and are not to be used to limit the scope of the claims. The flowcharts depict example operations that may vary within the scope of the claims. Additional operations may be performed; fewer operations may be performed; the operations may be performed in parallel; and the operations may be performed in a different order. In one example, the operations depicted in blocks 902-912 may be performed at least partially in parallel or concurrently. It will be understood that each block of the flowchart illustrations and/or block diagrams, and combinations of blocks in the flowchart illustrations and/or block diagrams, may be implemented by program code. The program code may be provided to a processor of a general purpose computer, special purpose computer, or other programmable machine or apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described as acting in certain combinations and even initially claimed as such, one or more features from a claimed combination may in some cases be excised from the combination, and the claimed combination may be directed to a sub-combination or variation of a sub-combination.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

While operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well may be horizontal or even slightly directed upwards. Unless otherwise specified, use of the terms “subsurface formation” or “subterranean formation” shall be construed as encompassing both areas below exposed earth and areas below earth covered by water such as ocean or fresh water.

As used herein, a phrase referring to “at least one of” a list of items refers to any combination of those items, including single members. As an example, “at least one of: a, b, or c” is intended to cover: a, b, c, a-b, a-c, b-c, and a-b-c.

### Example Implementations

Example implementations include the following:
Implementation #1: A wireline system configured for use in a wellbore drilled through one or more subsurface formations, the wireline system comprising: a power supply positioned at a surface of the wellbore and configured to supply electrical power; a wireline cable configured for deployment from the surface into the wellbore; and a wireline assembly configured for conveyance into the wellbore via the wireline cable, wherein the wireline assembly includes, an energy storage capacitor, and one or more downhole tools configured to receive stored electrical power from the energy storage capacitor.
Implementation #2: The wireline system of Implementation 1, wherein the wireline assembly includes one or more boost chargers coupled with the energy storage capacitor, wherein each boost charger includes a voltage booster configured to receive the electrical power at an input voltage and configured to output electrical power at a boosted voltage to the energy storage capacitor.
Implementation #3: The wireline system of any one or more of Implementations 1-2, wherein the wireline assembly further comprises: an input filter configured to filter the electrical power received via the wireline cable and to perform at least one of a reduction of ripple voltage components, a removal of resonant frequencies, or a smoothening of current and voltage waveforms in the received electrical power; and a multi-mode control system configured to control one or more properties of the one or more boost chargers and the energy storage capacitor.
Implementation #4: The wireline system of any one or more of Implementations 1-3, wherein the energy storage capacitor is charged by the power supply via the wireline cable and configured to emit a singular discharge including one pulse during each discharge cycle to the one or more downhole tools.
Implementation #5: The wireline system of any one or more of Implementations 1-4, wherein the energy storage capacitor is configured to emit a burst discharge including two or more pulses during each discharge cycle to the one or more downhole tools.
Implementation #6: The wireline system of any one or more of Implementations 1-5, wherein the one or more downhole tools include a pulsed power tool.
Implementation #7: The wireline system of any one or more of Implementations 1-6, wherein the pulsed power tool includes a triggering mechanism, and wherein the triggering mechanism is configured to activate a discharge of the energy storage capacitor.
Implementation #8: The wireline system of any one or more of Implementations 1-7, wherein the energy storage capacitor is configured to store and discharge at least one kilojoule of energy.
Implementation #9: An apparatus configured for use in a wellbore formed in one or more subsurface formations, the apparatus comprising: an energy storage capacitor configured to receive electrical power from a power supply positioned at a surface of a wellbore, wherein the energy storage capacitor is configured to couple to the power supply via a wireline cable; and one or more downhole tools configured to receive stored electrical power from the energy storage capacitor.
Implementation #10: The apparatus of Implementation 9, further comprising: one or more boost chargers coupled with the energy storage capacitor, wherein each boost charger includes a voltage booster configured to receive the electrical power from the power supply at an input voltage and configured to output electrical power at a boosted voltage to the energy storage capacitor.
Implementation #11: The apparatus of any one or more of Implementations 9-10, further comprising: an input filter configured to filter the electrical power received via the wireline cable and to perform at least one of a reduction of ripple voltage components, a removal of resonant frequencies, or a smoothening of current and voltage waveforms in the received electrical power; and a multi-mode control system configured to control one or more properties of the one or more boost chargers and the energy storage capacitor.
Implementation #12: The apparatus of any one or more of Implementations 9-11, wherein the energy storage capacitor is charged by the power supply via the wireline cable and configured to emit a singular discharge including one pulse during each discharge cycle to the one or more downhole tools, and wherein the one or more downhole tools include a pulsed power tool.
Implementation #13: The apparatus of any one or more of Implementations 9-12, wherein the energy storage capacitor is configured to emit a burst discharge including two or more pulses during each discharge cycle to the one or more downhole tools.
Implementation #14: The apparatus of any one or more of Implementations 9-13, wherein the pulsed power tool includes a triggering mechanism, and wherein the triggering mechanism is configured to activate a discharge of the energy storage capacitor.
Implementation #15: The apparatus of any one or more of Implementations 9-14, wherein the energy storage capacitor is configured to store and discharge at least one kilojoule of energy.
Implementation #16: A method comprising: lowering a wireline assembly into a wellbore via a wireline cable, wherein the wireline assembly includes an energy storage capacitor and a downhole tool, and wherein the wireline cable is electrically coupled with a power supply at a surface of the wellbore; charging, via the wireline cable, the energy storage capacitor with electrical power supplied from the power supply at the surface; and discharging, from the energy storage capacitor, a pulse of stored electrical power to the downhole tool.
Implementation #17: The method of Implementation 16, further comprising: filtering, via an input filter of the wireline assembly, the electrical power received from the power supply at the surface.
Implementation #18: The method of any one or more of Implementations 16-17, further comprising: boosting, via a boost charger of the wireline assembly, an input voltage of the electrical power received from the power supply to a higher output voltage; outputting, from the boost charger, the electrical power at the higher output voltage to the energy storage capacitor; and storing the electrical power at the higher output voltage in the energy storage capacitor, wherein the energy storage capacitor includes one or more capacitors coupled in series or in parallel.
Implementation #19: The method of any one or more of Implementations 16-18, further comprising: performing a pulsed power operation with the energy storage capacitor and the downhole tool, wherein the downhole tool is a pulsed power tool; and emitting a singular discharge including one pulse during each discharge cycle of the energy storage capacitor.
Implementation #20: The method of any one or more of Implementations 16-19, further comprising: emitting a burst discharge including two or more pulses during each discharge cycle of the energy storage capacitor.

1. A wireline system configured for use in a wellbore drilled through one or more subsurface formations, the wireline system comprising:
a power supply positioned at a surface of the wellbore and configured to supply electrical power;
a wireline cable configured for deployment from the surface into the wellbore, wherein the wireline cable is configured to transmit the electrical power; and
a wireline assembly configured for conveyance into the wellbore via the wireline cable, wherein the wireline assembly includes,
a voltage booster configured to increase a voltage of the electrical power transmitted by the wireline cable,
an energy storage capacitor, and
one or more downhole tools configured to receive stored electrical power from the energy storage capacitor.

2. The wireline system of claim 1, wherein the wireline assembly includes one or more boost chargers coupled with the energy storage capacitor, wherein each boost charger includes a voltage booster, wherein each voltage booster is configured to receive the electrical power transmitted by the wireline cable at an input voltage and configured to output electrical power at a boosted voltage to the energy storage capacitor.

3. The wireline system of claim 2, wherein the wireline assembly further comprises:
an input filter configured to filter the electrical power received via the wireline cable and to perform at least one of a reduction of ripple voltage components, a removal of resonant frequencies, or a smoothening of current and voltage waveforms in the received electrical power; and
a multi-mode control system configured to control one or more properties of the one or more boost chargers and the energy storage capacitor.

4. The wireline system of claim 1, wherein the energy storage capacitor is charged by the power supply via the wireline cable and configured to emit a singular discharge including one pulse during each discharge cycle to the one or more downhole tools.

5. The wireline system of claim 1, wherein the energy storage capacitor is configured to emit a burst discharge including two or more pulses during each discharge cycle to the one or more downhole tools.

6. The wireline system of claim 1, wherein the one or more downhole tools include a pulsed power tool.

7. The wireline system of claim 6, wherein the pulsed power tool includes a triggering mechanism, and wherein the triggering mechanism is configured to activate a discharge of the energy storage capacitor.

8. The wireline system of claim 1, wherein the energy storage capacitor is configured to store and discharge at least one kilojoule of energy.

9. An apparatus configured for use in a wellbore formed in one or more subsurface formations, the apparatus comprising:
an energy storage capacitor configured to receive electrical power from a power supply positioned at a surface of the wellbore, wherein the energy storage capacitor is configured to couple to the power supply via a wireline cable;
a voltage booster configured to increase a voltage of the electrical power transmitted via the wireline cable; and
one or more downhole tools configured to receive stored electrical power from the energy storage capacitor.

10. The apparatus of claim 9, further comprising:
one or more boost chargers coupled with the energy storage capacitor, wherein each boost charger includes a voltage booster configured to receive the electrical power from the power supply at an input voltage and configured to output electrical power at a boosted voltage to the energy storage capacitor.

11. The apparatus of claim 10, further comprising:
an input filter configured to filter the electrical power received via the wireline cable and to perform at least one of a reduction of ripple voltage components, a removal of resonant frequencies, or a smoothening of current and voltage waveforms in the received electrical power; and
a multi-mode control system configured to control one or more properties of the one or more boost chargers and the energy storage capacitor.

12. The apparatus of claim 9, wherein the energy storage capacitor is charged by the power supply via the wireline cable and configured to emit a singular discharge including one pulse during each discharge cycle to the one or more downhole tools, and wherein the one or more downhole tools include a pulsed power tool.

13. The apparatus of claim 12, wherein the energy storage capacitor is configured to emit a burst discharge including two or more pulses during each discharge cycle to the one or more downhole tools.

14. The apparatus of claim 12, wherein the pulsed power tool includes a triggering mechanism, and wherein the triggering mechanism is configured to activate a discharge of the energy storage capacitor.

15. The apparatus of claim 9, wherein the energy storage capacitor is configured to store and discharge at least one kilojoule of energy.

16. A method comprising:
lowering a wireline assembly into a wellbore via a wireline cable, wherein the wireline assembly includes an energy storage capacitor and a downhole tool, and wherein the wireline cable is electrically coupled with a power supply at a surface of the wellbore;
transmitting, via the wireline cable, electrical power from the power supply to the wireline assembly;
increasing, via a voltage booster, a voltage of the electrical power transmitted by the wireline cable;
charging via the electrical power at the increased voltage, the energy storage capacitor; and
discharging, from the energy storage capacitor, a pulse of stored electrical power to the downhole tool.

17. The method of claim 16, further comprising:
filtering, via an input filter of the wireline assembly, the electrical power received from the power supply at the surface.

18. The method of claim 16, further comprising:
boosting, via a boost charger of the wireline assembly, an input voltage of the electrical power received from the power supply to a higher output voltage, wherein the boost charger includes the voltage booster;
outputting, from the boost charger, the electrical power at the higher output voltage to the energy storage capacitor; and
storing the electrical power at the higher output voltage in the energy storage capacitor, wherein the energy storage capacitor includes one or more capacitors coupled in series or in parallel.

19. The method of claim 16, further comprising:
performing a pulsed power operation with the energy storage capacitor and the downhole tool, wherein the downhole tool is a pulsed power tool; and
emitting a singular discharge including one pulse during each discharge cycle of the energy storage capacitor.

20. The method of claim 19, further comprising:
emitting a burst discharge including two or more pulses during each discharge cycle of the energy storage capacitor.
